(19) United States
(12) Patent Application Publication
(10) Pub. No.: US 2009/0104579 A1
(43) Pub. Date: Apr. 23, 2009

(54) Mixing Device

(76) Inventor: Jurgen Mehrhof, Berlin (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/795,899

(22) PCT Filed: Jan. 19, 2006
(86) PCT No.: PCT/EP06/50316

§ 371 Date: Nov. 19, 2008

(30) Foreign Application Priority Data
Jan. 25, 2005 (DE) 20 2005 001 337.4

(51) Int. Cl. A61C 19/00

(52) U.S. Cl. 433/79

(57) ABSTRACT

A mixing apparatus has a mixing base on which components of a material, in particular a ceramic material, which are to be kept moist, are to be mixed, and a liquid reservoir and moistening means which communicate with the liquid reservoir and which are arranged and adapted to keep moist components which are to be kept moist, wherein the moistening means include a liquid carrier of an elongate configuration which provides for liquid transport in the longitudinal direction thereof and allows liquid delivery to components which are to be kept moist over the surface of the liquid carrier in transverse relationship with the longitudinal direction and which on the one hand is in communication with the liquid reservoir and which on the other hand adjoins a mixing surface on the mixing base.

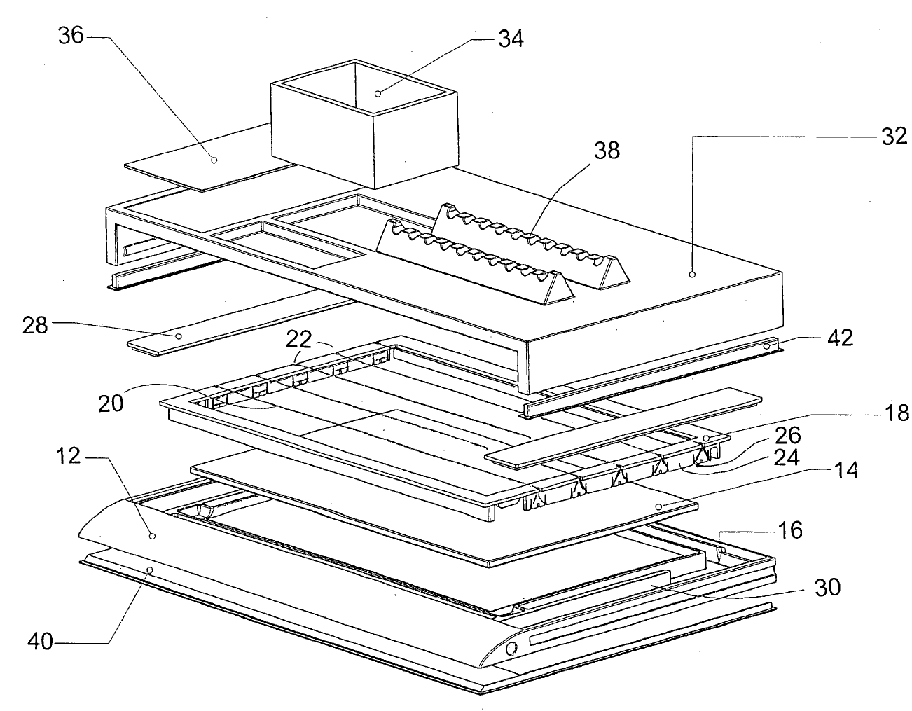

### BACKGROUND OF THE INVENTION

1. Technical Field

The invention concerns a mixing apparatus for mixing components of a material, in particular a dental ceramic, which are to be kept moist. The mixing apparatus includes a mixing base on which the components can be mixed. Moistening means and a liquid reservoir provide that the components are kept moist.

2. Description of the Background Art

In the specific situation the material whose components are to be mixed is a dental ceramic. The components are then ceramic materials and ceramic material liquid. Up to just a few years ago, ceramic materials (ceramic powder) were mixed on a glass plate with a given ceramic material liquid (generally a glycerine-based liquid, hereinafter also referred to as mixing liquid).

That involved the following problem:

Liquid always evaporates in the process of ceramic layering, that is to say building up the tooth-colored structure of a ceramic crown. Thus, during the layering procedure which often lasts for several hours, a certain further amount of another liquid frequently has to be added in order to keep the mixed ceramic material at the desired consistency. Distilled water is mostly used for that purpose in order to keep down the concentration of less volatile additives from the specific mixing liquids.

No specific mixing ratios for mixing ceramic materials are specified on the part of the manufacturers.

The mixed ceramic material is not of a consistency which always remains the same. It increasingly thickens and can completely dry out in breaks in the layering’ procedure. In order to avoid non-homogeneities, dried-out ceramic materials have to be disposed of and replaced by fresh ones.

In order to compensate for those problems, systems for keeping the materials moist were developed, which have now already become established on the dental market for some years.

Most systems are of the following configuration:

A moisture-permeable carrier plate which is between about 4 and 8 mm in thickness is disposed in a bowl which serves as a water reservoir. The carrier plate depending on the respective system involved comprises plastic material, cellulose or ceramic honeycomb. A thin membrane, a moisture-permeable intermediate layer, is formed between the carrier plate and the ceramic material. Ceramic material is thus to be maintained at a uniform consistency.

Other systems provide that the ceramic material is put directly on to a moisture-permeable carrier plate of ceramic. There are various structures here. Many have a plate surface which is of a flat symmetrical configuration while others again are provided with troughs which thus predetermine a fixed separation effect.

A disadvantage of those systems is that dry ceramic powders which are applied to a membrane which is already moist immediately absorb the liquid from the reservoir. However immediate liquid absorption is undesirable as the ceramic powder is now moistened for the major part, even before the mixing liquid which is specifically provided for that purpose can be absorbed.

In addition ceramic materials can only be kept at a uniform consistency if there is a sufficient reservoir of water available. Due to the system configuration involved, the carrier plate can only transport the moisture to the ceramic material as long as it is in direct contact with the water reservoir. In the known systems the reservoir is disposed directly underneath the carrier plate and is thus very small. If the level of liquid falls to such an extent that it no longer involves any contact with the carrier plate, it again draws the liquid out of the ceramic material mix which is disposed thereabove. The ceramic material is now too solid for processing and has to be extensively worked with a spatula again, after the water reservoir has been filled up afresh.

Example: With an eight-hour processing time in respect of about 15 grams of ceramic material the procedure of re-watering and working with a spatula has to be repeated up to four times.

In addition the running costs are very high as the threat of fungal infestation means that the membrane which in any case is expensive already has to be replaced after just one week, with some systems.

### SUMMARY OF THE INVENTION

Therefore the object of the Invention is to provide a mixing apparatus which very substantially avoids the disadvantages of the state of the art.

In accordance with the invention that object is attained by a mixing apparatus of the kind set forth in the opening part of this specification, In which the moistening means include a liquid carrier of an elongate configuration which provides for liquid transport In the longitudinal direction thereof and allows liquid delivery to components which are to be kept moist over the surface of the liquid carrier in transverse relationship with the longitudinal direction thereof and which on the one hand is in communication with the liquid reservoir and which on the other hand adjoins a mixing surface on the mixing base.

The invention is based on the use of a new technology for liquid transport.

Preferably the liquid carrier is a cord or a cable comprising a plurality of artificial and/or natural fiber filaments, which dips at least with a short portion into the liquid reservoir.

It has been found that components of a ceramic material can be kept uniformly moist over many hours and even days with such a mixing apparatus.

It has been found that particularly uniform and reliable liquid transport is possible if the cord is taut. As an alternative to the cord being tensioned or in addition, the cord may have a firm core of wire or plastic material which performs a static carrier function.

Instead of a cord a bar can also serve as the elongate liquid carrier. Such a bar has capillaries or interconnecting pores which serve for liquid transport in the longitudinal direction and which are open towards the surface of the bar in such a way that liquid delivery is possible. Such a bar, laid over the mixing base, can have the same action as a cord. The bar projects for example with an angled end into the liquid reservoir.

In order to permit as many mixing surfaces as possible or the largest possible mixing surface, on a mixing base of corresponding size, preferably there are provided a plurality of liquid carriers in the form of a plurality of bars or cords which are stretched over the mixing base.

Those cords or bars preferably extend in mutually parallel relationship.

It is particularly advantageous If the cords are tensioned by way of a tensioning frame which is arranged movably relative to the mixing base. Then the cords can be removed from the mixing base by taking the tensioning frame away or by pivoting it away so as to permit unimpeded mixing of the ceramic materials.

Bars as the liquid carriers would have to be fitted on to a corresponding frame.

In order to be able to easily remove the tensioning frame together with cords from the mixing base the tensioning frame can be fixed pivotably about a pivot axis In such a way that in a first pivotal position of the tensioning frame the cords lie on the mixing base and the cords are to be pivoted away from the mixing base by pivoting the tensioning frame into a second position. In that case it is particularly advantageous if the tensioning frame with the cords fixed thereto Is arranged and formed in such a way that the tensioning frame and a respective portion of the cords which are fixed to the tensioning frame dips partially into the liquid reservoir in the first pivotal position. That ensures that the cords as the liquid carriers are always automatically brought Into communication with the liquid reservoir when the tensioning frame is pivoted into Its first pivotal position in which the cords adjoin the ceramic materials which are to be kept moist, in order to keep them moist.

If the cords are tensioned in parallel relationship with the pivot axis and the tensioning frame is to be pivoted about a pivot axis which is remote from a user, the pivoting frame is not in the way of the user, in the condition of being pivoted away. Conversely (in the first pivotal position) the cords appropriately form ‘lines’ on the mixing base, which lines can serve for orientation purposes.

Polyamide fiber filaments or polypropylene as synthetic fiber filaments and cellulose as a constituent of the natural fiber filaments have proven to be suitable materials for the cords.

The mixing base is preferably formed by a mixing plate having a smooth, flat, closed mixing surface. A glass plate is particularly suitable.

In principle ceramic material in the mixed condition is picked up with a special brush. The process of picking up the material, with known membranes of moisturising systems which are usual nowadays, operates poorly, due to the rougher surface thereof. As the surface of glass plates is substantially smoother than the known membranes a mixing base of that kind in the form of a glass plate permits components to be easily and efficiently picked up.

In addition a mixing plate in the form of a transparent glass plate allows an underneath support for the glass plate to bear markings which are visible through the glass plate and which identify the line of the cords so that the line of the cords can be seen even when the tensioning frame with the cords is removed from the glass plate, that is to say for example pivoted away therefrom.

The advantages of the invention are reflected in the following description of a typical working procedure:

The ceramic materials are mixed on a glass plate which, as already mentioned, is most suitable for picking up with a brush. For that purpose the tensioning frame is removed or pivoted away.

A grid division arrangement identified by markings is available as an aid for positioning the materials, underneath the transparent glass plate.

As the ceramic material is not immediately saturated upon being applied to the glass plate it can be mixed with the liquid which is specifically provided for that purpose by the manufacturer, without being subjected to the pressure of time.

The tensioning frame is now lowered on to the glass plate. The cords provided for liquid transport are disposed in a taut condition on the tensioning frame.

The cords are taut transversely over the entire width of the glass plate. They connect the individual islands of ceramic materials, which have already been mixed, at the respective upper boundary thereof, to the liquid from the large liquid reservoir. With a capacity of 220 ml, that is now up to ten times greater than in the case of known membrane systems. In that case the liquid is available down to the last: drop as in a preferred configuration the cords extend entirely to the bottom of the liquid reservoir.

The ceramic material now maintains precisely the desired consistency over many days.

The cords are substantially less expensive than a membrane.

The mixing plate unit with liquid reservoir can be pushed into a kind of garage (covering) in interruptions in the layering procedure, to protect it from contamination. For safe transport a rail system connects the two individual elements in the inserted condition. The independent cover further serves to receive the brush rinsing basin, the scraping-off sponge, an instrument carrier and provides space for some carriers for material to be burnt.

### BRIEF DESCRIPTION OF THE DRAWING

The invention will now be described in greater detail by means of an embodiment by way of example illustrated in the FIGURE which is an exploded perspective view of the invention.

### DETAILED DESCRIPTION OF THE INVENTION

Referring to the FIGURE, therein illustrated is a mixing apparatus 10 in the form of an exploded view. Essential components of the mixing apparatus 10 are an underneath support 12 in the form of a base element, on which is placed a glass plate 14 as a mixing plate which has a closed smooth surface on its top side. Incorporated into the support 12 is a liquid or water reservoir 16 in the form of a recess which surrounds the glass plate 14 on three sides. A tensioning frame 18 carries a total of six cords 20 which are tensioned in mutually parallel relationship and which are locally positioned on the tensioning frame 18 by notches 22. The tensioning frame 18 has a fixing limb 24 which, when the tensioning frame 18 is set in position, projects into the liquid reservoir 16. The fixing limb 24 has slots 26 which narrow with increasing depth and which serve for fixing the cords 20. The ends of the cords 20, which are fixed to the fixing limb 24, thus project into the corresponding liquid, for example water, when the liquid reservoir 16 is filled.

Those are in that respect the essential component parts of the mixing apparatus 10 which already bring about the action according to the invention.

The water reservoir 16 can be covered by means of covers 28 which are to be fitted in position on both sides of the glass plate 14. An edge 30 in the respective water reservoir provides that a pressure on a rear portion of a respective cover 28 means that the cover 28 lifts in the front region and can be easily removed in order for example to fill up the liquid reservoir 16.

Supplemental component parts of the mixing apparatus 10 are a protective case 32, also referred to as the garage, with a rinsing basin 34 disposed thereon, and a setting-down deposit plate 36 of metal. On its top side, the protective case 32 also has setting-down deposit projections 38 which are also provided with recesses and on which brushes, spatulas or the like can be set down.

The protective case 32 is of such a configuration that the support 12 together with the glass plate 14 and the tensioning frame 28 can be pushed under the protective case 32 and protected in that way. That is facilitated by sliding feet 40 on the underside of the support 12.

The protective case 32 has adhering silicone feet 42 which are less slidable than the sliding feet 40 so that the protective case 32 is somewhat less easy to displace than the support 12.

The support 12 and the protective case 32 can comprise injection-molded or deep-drawn plastic material. The tensioning frame 18 can also comprise injection-molded plastic material.

The FIGURE does not show markings on the support 12 underneath the glass plate 14, which indicate the line of the cords 20 so that the line of the cords 20 is known even when the tensioning frame 18 has been removed from the rest of the support 12 and the glass plate 14.

1-19. (canceled)

20. A mixing apparatus comprising:
(a) a mixing base on which components of a material, in particular a ceramic material, which are to be kept moist, are to be mixed;
(b) moistening means adjoining a mixing surface on the mixing base, said moistening means including at least one liquid carrier of an elongate configuration which provides for liquid transport in the longitudinal direction thereof and allows liquid delivery to the components which are to be kept moist over the surface of the liquid carrier in transverse relationship with the longitudinal direction; and
(c) a liquid reservoir in communication with the at least one liquid carrier arranged to keep moist the components which are to be kept moist.

21. A mixing apparatus as set forth in claim 20, wherein the at least one liquid carrier is a cord comprising a plurality of synthetic and/or natural fiber filaments, which has at least a short portion in the liquid reservoir.

22. A mixing apparatus as set forth in claim 21, wherein the cord is taut.

23. A mixing apparatus as set forth in claim 21, wherein the synthetic fiber filaments are polyamide fiber filaments.

24. A mixing apparatus as set forth in claim 21, wherein the natural fiber filaments contain cellulose.

25. A mixing apparatus as set forth in claim 20, wherein the at least one liquid carrier is a plurality of liquid carriers in the form of a plurality of cords which are stretched over the mixing base.

26. A mixing apparatus as set forth in claim 25, wherein the plurality of cords extend in mutually parallel relationship.

27. A mixing apparatus as set forth in claim 25, wherein the cords are tensioned by way of a tensioning frame which is arranged movably relative to the mixing base.

28. A mixing apparatus as set forth in claim 27, wherein the tensioning frame is fixed pivotably about a pivot axis in such a way that in a first pivotal position of the tensioning frame the cords rest on the mixing base and are to be pivoted away from the mixing base by pivotal movement of the tensioning frame into a second position.

29. A mixing apparatus as set forth in claim 28, wherein the tensioning frame with the cords fixed thereto is arranged and formed in such a way that the tensioning frame and a respective portion of each of the cords which are fixed to the tensioning frame partially dips into the liquid reservoir in the first pivotal position.

30. A mixing apparatus as set forth in claim 28, wherein the cords are tensioned in parallel relationship with the pivot axis.

31. A mixing apparatus as set forth in claim 28, wherein the mixing base is a rectangular mixing plate and the liquid reservoir is a respective liquid reservoir arranged along two oppositely disposed longitudinal sides of the rectangular mixing plate while the pivot axis extends along a third side of the mixing plate, which is enclosed by the two oppositely disposed sides of the mixing plate.

32. A mixing apparatus as set forth in claim 20, wherein the mixing base is formed by a mixing plate having a smooth, flat, closed mixing surface.

33. A mixing apparatus as set forth in claim 32, wherein the mixing plate is a glass plate.

34. A mixing apparatus as set forth in claim 32, wherein the at least one liquid carrier is tensioned over the mixing plate.

35. A mixing apparatus as set forth in claim 32, wherein the at least one liquid carrier rests on the mixing plate.

36. A mixing apparatus as set forth in claim 32, further comprising an underneath support which carries the mixing plate and in which the liquid reservoir is formed laterally beside the mixing plate in such a way that a level of liquid below the mixing surface is possible.

37. A mixing apparatus as set forth in claim 36, wherein the liquid reservoir is a respective liquid reservoir formed at each of two sides of the mixing plate.

38. A mixing apparatus as set forth in claim 37, wherein the mixing plate is rectangular and the liquid respective reservoirs are arranged along two oppositely disposed longitudinal sides of the mixing plate.

39. A mixing apparatus as set forth in claim 36, wherein the mixing plate is a transparent material with a closed smooth surface and the underneath support carries markings which are visible through the transparent material and which identify the lines of the cords.
